(19) United States
(12) Patent Application Publication
(10) Pub. No.: US 2009/0211383 A1
(43) Pub. Date: Aug. 27, 2009

(54) EMERGENCY STOPS AND BRAKE DEVICES FOR MOTORS

(75) Inventors: Donald J. Christensen, Phoenix, AZ (US); David M. Eschborn, Gilbert, AZ (US); Glenn H. Lane, Chandler, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/853,213

(22) Filed: Sep. 11, 2007

(51) Int. Cl. F16K 17/36

(52) U.S. Cl. 74/2

(57) ABSTRACT

An emergency stop for a brake device for a motor includes a blocking device, a spring, and an inhibiting material. The blocking device is movable between a first position, at which it allows rotation of the drive shaft, and a second position, at which it at least substantially stops rotation of a drive shaft of the motor. The spring is housed at least partially within the housing, and urges the blocking device toward the first position. The inhibiting material at least partially surrounds the blocking device and/or the spring, and has a melting point that is at least substantially known. The inhibiting material at least substantially prevents movement of the blocking device from the first to the second position when a temperature is below the melting point, and allows movement of the blocking device from the first to the second position when the temperature is above the melting point.

### STATEMENT REGARDING FEDERALLY SPONSORED RESEARCH OR DEVELOPMENT

This invention was made with Government support under contract number N00024-04-C-2118 awarded by the United States Navy. The Government has certain rights in this invention.

### TECHNICAL FIELD

The present invention relates generally to motors and, more particularly, to emergency stops and brake devices for motors.

### BACKGROUND

Braking devices are often used for various types of motors to help slow or stop movement of the motor or a drive shaft thereof. For example, in a typical motor having a rotational drive shaft connected thereto, a braking device may include one or more brake rotors coupled to the drive shaft. The brake rotors may slow or stop movement of the motor when the brake rotors come into contact with a friction-inducing device. Conversely, when the brake rotors are moved away from the friction-inducing device, for example by an actuator, the rotors, and thereby the motor, are allowed to move freely. While such braking devices generally work quite effectively, braking devices may work in less than an ideal fashion in certain emergency situations with high temperatures, such as in a fire, which for example could have an undesirable impact on the effectiveness of the friction-inducing device.

Accordingly, it is desired to provide an emergency stop for a braking device that results in improved performance of the braking device, particularly in emergency situations such as in a fire. It is further desired to provide a braking device with improved performance, particularly in emergency situations such as in a fire. Furthermore, other desirable features and characteristics of the present invention will be apparent from the subsequent detailed description and the appended claims, taken in conjunction with the accompanying drawings and the foregoing technical field and background.

### BRIEF SUMMARY

In accordance with an exemplary embodiment of the present invention, an emergency stop for a brake device for a motor, wherein the brake device has a housing and the motor has a drive shaft configured to rotate, is provided. The emergency stop comprises a blocking device, a spring, and an inhibiting material. The blocking device is disposed within at least partially within the housing, and is movable between a first position and a second position. When at the first position, the blocking device allows rotation of the drive shaft. When at the second position, the blocking device at least substantially stops rotation of the drive shaft. The spring is configured to be housed at least partially within the housing, and to urge the blocking device toward the second position. The inhibiting material at least partially surrounds the blocking device, the spring, or both, and comprises a material with a melting point that is at least substantially known. The inhibiting material is configured to at least substantially prevent movement of the blocking device from the first position to the second position when a temperature of the brake device is below the melting point, and to allow movement of the blocking device from the first position to the second position when the temperature of the brake device is above the melting point.

In accordance with another exemplary embodiment of the present invention, a brake device for a motor with a drive shaft configured to rotate is provided. The brake device comprises a housing and an emergency stop. The emergency stop is disposed at least partially within the housing, and comprises a blocking device, a spring, and an inhibiting material. The blocking device is movable between a first blocking device position and a second blocking device position. When at the first blocking device position, the blocking device allows rotation of the drive shaft. When at the second blocking device position, the blocking device at least substantially stops rotation of the drive shaft. The spring is disposed at least partially within the housing, and is configured to urge the blocking device toward the second blocking device position. The inhibiting material at least partially surrounds the blocking device, the spring, or both, and comprises a material with a melting point that is at least substantially known. The inhibiting material is configured to at least substantially prevent movement of the blocking device from the first blocking device position to the second blocking device position when a temperature of the brake device is below the melting point, and to allow movement of the blocking device from the first blocking device position to the second blocking device position when the temperature of the brake device is above the melting point.

In accordance with a further exemplary embodiment of the present invention, a brake device for a motor with a drive shaft configured to rotate is provided. The brake device comprises a housing, a rotor, and an emergency stop. The rotor is disposed proximate to the housing, and is coupled to the drive shaft. The emergency stop is disposed at least partially within the housing, and comprises a blocking device, a spring, and a retaining material. The blocking device is movable between a first blocking device position and a second blocking device position. When at the first blocking device position, the blocking device does not contact the rotor, and thereby allows rotation of the drive shaft. When at the second blocking device position, the blocking device contacts the rotor, and thereby at least substantially stops rotation of the drive shaft. The spring is configured to be housed at least partially within the housing, and to urge the blocking device toward the second blocking device position. The spring is movable between a first spring position and a second spring position. When the spring is at the first spring position, the blocking device is allowed to remain in the first blocking device position. When the spring is at the second spring position, the spring at least facilitates movement of the blocking device from the first blocking device position to the second blocking device position. The retaining material at least partially surrounds the blocking device, the spring, or both, and comprises a material with a melting point that is at least substantially known. The retaining material is configured to at least substantially prevent movement of the spring from the first spring position to the second spring position when a temperature of the brake device is below the melting point, and to allow movement of the spring from the first spring position to the second spring position when the temperature of the brake device is above the melting point.

Other independent features and advantages of the preferred embodiments of the check valves will become apparent from the following detailed description, taken in conjunction with the accompanying drawings which illustrate, by way of example, the principles of the invention.

### BRIEF DESCRIPTION OF THE DRAWINGS

FIG. 1 is an isometric view of a brake device with an emergency stop, in accordance with an exemplary embodiment of the present invention;

FIG. 2 is an isometric, cross-sectional view of the brake device of FIG. 1 showing a portion of the emergency stop, in accordance with an exemplary embodiment of the present invention;

FIG. 3 is a cross-sectional view of an emergency stop that can be used in a brake device, such as the brake device of FIG. 1, shown in a first position, in accordance with an exemplary embodiment of the present invention;

FIG. 4 is a cross-sectional view of the emergency stop of FIG. 3, shown in a second position, in accordance with an exemplary embodiment of the present invention;

FIG. 5 is a cross-sectional view of an emergency stop that can be used in a brake device, such as the brake device of FIG. 1, shown in a first position, in accordance with another exemplary embodiment of the present invention; and

FIG. 6 is a cross-sectional view of the emergency stop of FIG. 5, shown in a second position, in accordance with an exemplary embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background or the following detailed description.

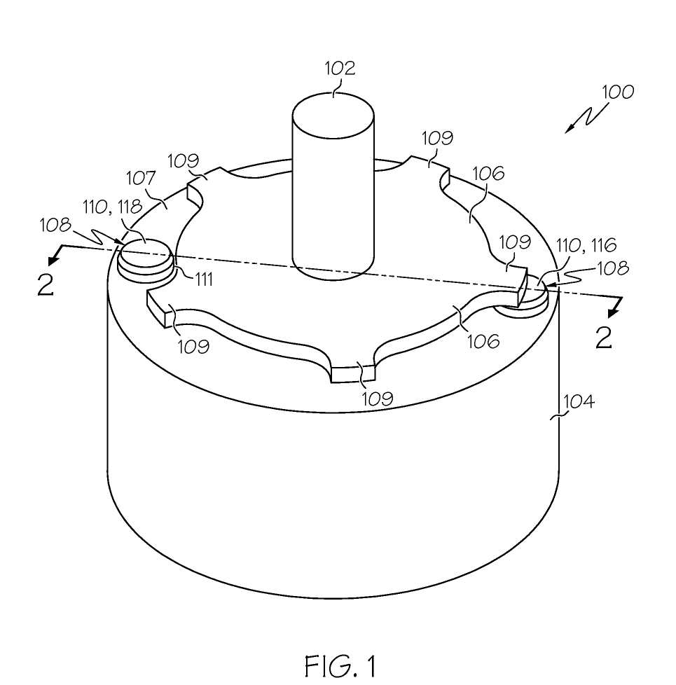

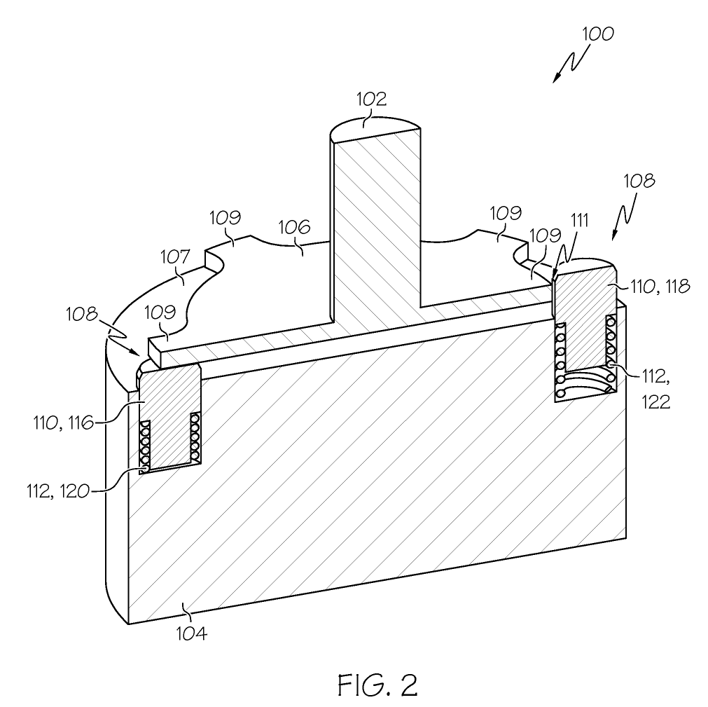

FIGS. 1 and 2 depict a brake device 100 for use in connection with a motor having a drive shaft 102 in accordance with an exemplary embodiment of the present invention. Specifically, FIG. 1 is an isometric view of an exemplary embodiment of the brake device 100, and FIG. 2 is an isometric cross-sectional view of the brake device 100 of FIG. 1 showing a portion of an emergency stop thereof. As depicted in FIGS. 1 and 2, the brake device 100 includes a housing 104, a rotor 106, and an emergency stop 108.

The rotor 106 is disposed proximate to the housing 104, and is coupled to the drive shaft 102. The rotor 106 is movable between a first rotor position and a second rotor position. For example, the rotor 106 may be moved at least in part by an actuator (not depicted in FIGS. 1 and 2) to the first rotor position when braking is not desired, and to the second rotor position when braking is desired. In one embodiment, the rotor 106 is connected to the drive shaft 102, and an actuator (not depicted) moves the rotor 106 and the drive shaft 102 together away from and toward the housing 104, between the first rotor position and the second rotor position.

When the rotor 106 is at the first rotor position, the rotor 106 allows rotation of the drive shaft 102. For example, in one embodiment, when the rotor 106 is at the first rotor position, there is a gap between the rotor 106 and a friction-inducing surface 107 of the housing 104, thereby allowing rotation of the rotor 106 and the drive shaft 102. Conversely, when the rotor 106 is at the second rotor position, the rotor 106 at least substantially stops rotation of the drive shaft 102. For example, in one embodiment, when at the second rotor position, the rotor 106 contacts the friction-inducing surface 107 of the housing 104, which stops rotation of the rotor 106, thereby also stopping rotation of the drive shaft 102.

As shown in FIGS. 1 and 2, in a preferred embodiment, the rotor 106 includes a plurality of protruding edges 109 extending therefrom. As will be discussed further below, in this preferred embodiment, the protruding edges 109 represent at least one point at which the rotor 106 contacts the emergency stop 108 during an emergency braking event, for example in the case of a fire.

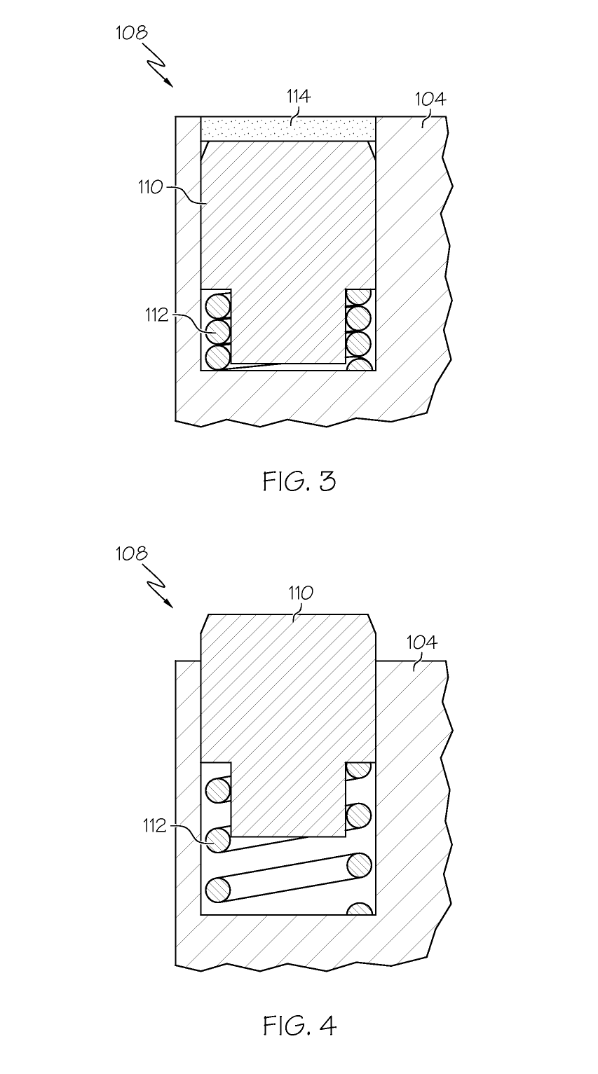

The emergency stop 108 is disposed at least partially within the housing 104, and is configured to stop the drive shaft 102 in an emergency involving high temperatures, for example in the event of a fire, in which the friction-inducing surface 107 may be compromised. The emergency stop 108 comprises one or more blocking devices 110 (depicted in FIGS. 1 and 2) and one or more corresponding springs 112 (depicted in FIG. 2), as well as an inhibiting material (described further below in connection with FIGS. 3-6). Two blocking devices 110, each with a spring 112, are depicted in FIGS. 1 and 2. Specifically, FIGS. 1 and 2 depict a first blocking device 116 and a second blocking device 118 (FIGS. 1 and 2), along with a corresponding first spring 120 and a second spring 122 (FIG. 2), respectively. However, it will be appreciated that the number of blocking devices 110 and/or springs 112 may vary in other embodiments. In a preferred embodiment, the emergency stop 108 is disposed proximate an end of the drive shaft 102.

The blocking devices 110 are disposed within the housing 104, and are movable between a first blocking device position and a second blocking device position at least in part by a corresponding spring 112. When at the first blocking device position, the blocking devices 110 allow rotation of the drive shaft 102. For example, in a preferred embodiment, when the blocking devices 110 are at the first blocking device position, the blocking devices 110 do not contact the rotor 106, and therefore do not stop rotation of the rotor 106 or the drive shaft 102. Conversely, when at the second blocking device position, the blocking devices 110 at least substantially stop rotation of the drive shaft 102. For example, in a preferred embodiment, when the blocking devices 110 are at the second blocking device position, the blocking devices 110 contact one of the protruding edges 109 of the rotor 106, as depicted at point 111 in FIGS. 1 and 2 in connection with the second blocking device 118, and block rotation of the rotor 106 and hence, rotation of the drive shaft 102.

Turning now to FIGS. 3 and 4, a close-up view of a first exemplary embodiment of the emergency stop 108 is depicted, shown both in a first position (FIG. 3) and a second position (FIG. 4). As depicted in FIGS. 3 and 4, the emergency stop 108 is disposed within the housing 104, and comprises a blocking device 110, a spring 112, and an inhibiting material 114. While the housing 104 is depicted in FIGS. 3 and 4 as being the same housing as the brake device 100, it will be appreciated that in certain embodiments the emergency stop 108 may have a separate housing disposed within the housing 104. Also, as discussed above, the emergency stop 108 may include multiple blocking devices 110, along with multiple corresponding springs 112. Similarly, the emergency stop 108 may include multiple inhibiting materials 114. It will be appreciated that in certain embodiments the emergency stop 108 may be manufactured and/or sold as part of the brake device 100, while in other embodiments the emergency stop 108 may be manufactured and/or sold separately.

Each spring 112 is housed at least partially within the housing 104, and is configured to urge a corresponding blocking device 110 toward the second blocking device position referenced above. Specifically, each spring 112 is movable between a first spring position (depicted in FIG. 3) and a second spring position (depicted in FIG. 4). When a particular spring 112 is in the first spring position, a corresponding blocking device 110 is allowed to remain in the first blocking device position of FIG. 3. Conversely, when a particular spring 112 is in the second spring position, the spring 112 at least facilitates movement of a corresponding blocking device 110 from the first blocking device position to the second blocking device position of FIG. 4.

The inhibiting material 114 at least partially surrounds one or more blocking devices 110 and/or springs 112, and is preferably disposed at least partially within the housing 104. The inhibiting material 114 comprises a material with a melting point (hereafter referred to as the “melting point”) that is at least substantially known. Specifically, the retaining material 114 is configured to at least substantially prevent movement of the blocking device 110 from the first blocking device position to the second blocking device position when a temperature of the brake device 100 is below the melting point, and to allow movement of the blocking device 110 from the first position to the second position when the temperature of the brake device 100 is above the melting point.

For example, in the embodiment depicted in FIGS. 3 and 4, the inhibiting material 114 comprises a covering material that at least partially seals off the blocking devices 110 within the housing 104 when the temperature of the brake device 100 is below the melting point. In this embodiment, the inhibiting material 114 effectively serves as a cap on the blocking devices 110 under normal operating conditions. Specifically, when the temperature of the brake device 100 is below the melting point, the inhibiting material 114 blocks the blocking device 110 from movement away from the first blocking device position and thereby keeps the blocking device 110 in the first blocking device position, as shown in FIG. 3. Conversely, when the temperature of the brake device 100 is above the melting point, the inhibiting material 114 melts, and no longer blocks or seals the blocking device 110. Accordingly, the blocking device 110 is moved by the spring 112 to the second blocking device position, as shown in FIG. 4.

The inhibiting material 114 can take any one of a number of different shapes, and for example may comprise a pin or a coin-shaped material, among various other possible shapes. In a preferred embodiment, the inhibiting material 114 comprises a eutectic alloy or a plastic. However, in other embodiments, the inhibiting material 114 may comprise a zinc material and/or various other types of materials or combinations thereof with a melting point that is at least substantially known.

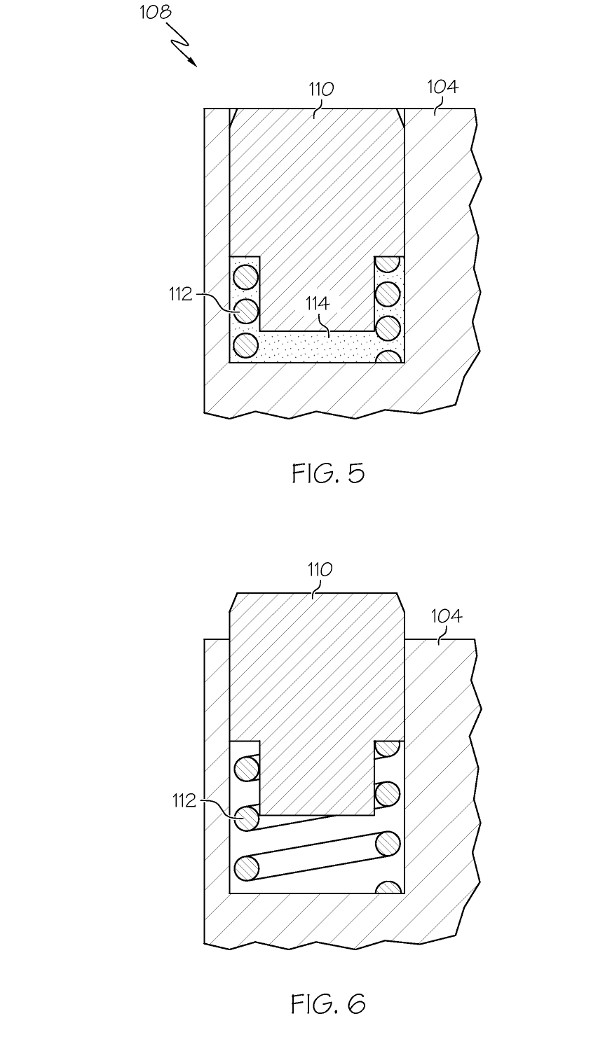

Turning now to FIGS. 5 and 6, a close-up view of a second exemplary embodiment of the emergency stop 108 is depicted, shown both in a first position (FIG. 5) and a second position (FIG. 6). As depicted in FIGS. 5 and 6, the emergency stop 108 in this embodiment similarly is disposed within the housing 104, and comprises a blocking device 110, a spring 112, and an inhibiting material 114. The structure and function of this second exemplary embodiment of the emergency stop 108 is at least substantially identical to the first exemplary embodiment depicted in FIGS. 3 and 4 and discussed above, except for the placement of the inhibiting material 114.

Specifically, in the embodiment of FIGS. 5 and 6, the inhibiting material 114 comprises a restraining material that is at least partially in a solid state around a coil of the spring 112 when the temperature of the brake device 100 is below the melting point. Accordingly, when the temperature of the brake device 100 is below the melting point, the spring 112 is inhibited or prevented from moving to the second spring position, and the blocking device 110 is thus inhibited or prevented from moving to the second blocking device position. As a result, the blocking device 110 remains in the first blocking device position, as shown in FIG. 5. Conversely, when the temperature of the brake device 100 is above the melting point, the inhibiting material 114 melts and no longer inhibits the spring 112 from moving to the second spring position. As a result, the blocking device 110 is moved by the spring 112 to the second blocking device position, as shown in FIG. 6.

Returning now to FIGS. 1 and 2, in a preferred embodiment, the emergency stop 108 is configured so that at least one blocking device 110 contacts the rotor 106 when the temperature of the brake device 100 is above the melting point. Specifically, as shown in FIGS. 1 and 2, in this preferred embodiment, the blocking devices 110 are disposed relative to the protruding edges 109 of the rotor 106, so that, when the temperature of the brake device 100 is above the melting point, at least one of the blocking devices 110 will not be blocked from moving to the second blocking device position. Thus, in this embodiment, the blocking devices 110 are spaced apart and aligned such that at least one of the blocking devices 110 contacts at least one of the one or more protruding edges 109 of the rotor 106 when the temperature of the brake device 100 is above the melting point. For example, as shown in FIGS. 1 and 2, even when the first blocking device 116 is prevented from reaching the second blocking device position because it is blocked by one of the protruding edges 109 of the rotor 106, the second blocking device 118 is free to block another one of the protruding edges 109 of the rotor 106, to thereby stop rotation of the rotor 106 and the drive shaft 102.

Having now described various structural features of an exemplary embodiment of the brake device 100 and the emergency stop 108, a brief description of the operation of an exemplary embodiment of the brake device 100 and the emergency stop 108 will now be provided. When the temperature of the brake device 100 is below the melting point of the inhibiting material 114, the inhibiting material 114 allows the spring 112 to remain in the first spring position and the blocking device 110 to remain in the first blocking device position. For example, in the embodiment of FIGS. 3 and 4, the inhibiting material 114 seals or otherwise blocks the blocking device 110 from moving to the second blocking device position when the temperature of the brake device 100 is below the melting point. Alternatively, in the embodiment of FIGS. 5 and 6, the inhibiting material 114 interferes with the operation of the spring 112 when the temperature of the brake device 100 is below the melting point.

In either example, the blocking device 110 does not contact the rotor 106 when the temperature of the brake device 100 is below the melting point. Accordingly, the drive shaft 102 is allowed to rotate freely, provided that the rotor 106 does not contact the friction-inducing surface 107 of the housing 104. If the rotor 106 does contact the friction-inducing surface 107 (for example when braking is desired under normal, non-emergency circumstances), then the contact between the friction-inducing surface 107 and the rotor 106 causes the drive shaft 102 to stop. However, as mentioned above, the friction-inducing surface 107 may be compromised in certain emergency events with high temperatures, such as in a fire.

When the temperature of the brake device 100 exceeds the melting point of the inhibiting material 114, the inhibiting material 114 melts, and thereby no longer inhibits movement of the blocking device 110 and/or the spring 112. Accordingly, the spring 112 moves the blocking device 110 to the second position, at which the blocking device 110 (or a portion thereof) blocks movement of a protruding edge 109 of the rotor 106. The blocking device 110 thereby stops movement of the rotor 106 and the drive shaft 102.

Accordingly, there has been provided a brake device 100 and an emergency stop 108 for a motor that allow for improved braking performance, particularly in emergency situations with high temperatures, such as in a fire. It will also be appreciated that the brake device 100 and the emergency stop 108 can be used in connection with any number of numerous different types of motors, and in connection with any number of different types of devices, systems, and environments.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. An emergency stop for a brake device for a motor, wherein the brake device has a housing and the motor has a drive shaft configured to rotate, and wherein the emergency stop comprises:
a blocking device disposed at least partially within the housing and movable between:
a first position, at which the blocking device allows rotation of the drive shaft; and
a second position, at which the blocking device at least substantially stops rotation of the drive shaft;
a spring configured to be housed at least partially within the housing and to urge the blocking device toward the second position; and
an inhibiting material at least partially surrounding the blocking device, the spring, or both, the inhibiting material comprising a material with a melting point that is at least substantially known, the inhibiting material configured to:
at least substantially prevent movement of the blocking device from the first position to the second position when a temperature of the brake device is below the melting point; and
allow movement of the blocking device from the first position to the second position when the temperature of the brake device is above the melting point.

2. The emergency stop of claim 1, wherein the inhibiting material comprises a eutectic alloy.

3. The emergency stop of claim 1, wherein the inhibiting material comprises a plastic.

4. The emergency stop of claim 1, wherein the blocking device is at least partially sealed within the housing by the inhibiting material when the temperature of the brake device is below the melting point.

5. The emergency stop of claim 1, wherein the inhibiting material is at least partially in a solid state around a coil of the spring when the temperature of the brake device is below the melting point.

6. The emergency stop of claim 1, wherein:
the brake device includes a rotor; and
the blocking device is configured to contact the rotor, to thereby at least substantially stop movement of the drive shaft, when the temperature of the brake device is above the melting point.

7. The emergency stop of claim 6, wherein the rotor has a plurality of protruding edges, and the emergency stop further comprises:
one or more additional blocking devices, wherein the blocking device and the one or more additional blocking devices are aligned such that at least one of them contacts at least one of the plurality of protruding edges when the temperature of the brake device is above the melting point.

8. A brake device for a motor with a drive shaft configured to rotate, the brake device comprising:
a housing; and
an emergency stop disposed at least partially within the housing, the emergency stop comprising:
a blocking device movable between:
a first blocking device position, at which the blocking device allows rotation of the drive shaft; and
a second blocking device position, at which the blocking device at least substantially stops rotation of the drive shaft;
a spring disposed at least partially within the housing and configured to urge the blocking device toward the second blocking device position; and
an inhibiting material at least partially surrounding the blocking device, the spring, or both, the inhibiting material comprising a material with a melting point that is at least substantially known, the inhibiting material configured to:
at least substantially prevent movement of the blocking device from the first blocking device position to the second blocking device position when a temperature of the brake device is below the melting point; and
allow movement of the blocking device from the first blocking device position to the second blocking device position when the temperature of the brake device is above the melting point.

9. The brake device of claim 8, wherein the inhibiting material comprises a eutectic alloy.

10. The brake device of claim 8, wherein the inhibiting material comprises a plastic.

11. The brake device of claim 8, wherein the blocking device is at least partially sealed within the housing by the inhibiting material when the temperature of the brake device is below the melting point.

12. The brake device of claim 8, further comprising:
a rotor disposed proximate to the housing and coupled to the drive shaft;
wherein the blocking device is configured to contact the rotor, to thereby at least substantially stop movement of the drive shaft, when the temperature of the brake device is above the melting point.

13. The brake device of claim 12, wherein:
the rotor has a plurality of protruding edges; and
the emergency stop comprises one or more additional blocking devices, wherein the blocking device and the one or more additional blocking devices are aligned such that at least one of them contacts at least one of the plurality of protruding edges when the temperature of the brake device is above the melting point.

14. The brake device of claim 8, wherein the emergency stop is disposed proximate an end of the drive shaft.

15. A brake device for a motor with a drive shaft configured to rotate, the brake device comprising:
a housing;
a rotor disposed proximate to the housing and coupled to the drive shaft; and
an emergency stop disposed at least partially within the housing, the emergency stop comprising:
a blocking device movable between:
a first blocking device position, at which the blocking device does not contact the rotor, and thereby allows rotation of the drive shaft; and
a second blocking device position, at which the blocking device contacts the rotor, and thereby at least substantially stops rotation of the drive shaft;
a spring configured to be housed at least partially within the housing and to urge the blocking device toward the second blocking device position, wherein the spring is movable between:
a first spring position, in which the blocking device is allowed to remain in the first blocking device position; and
a second spring position, in which the spring at least facilitates movement of the blocking device from the first blocking device position to the second blocking device position; and
a retaining material at least partially surrounding the blocking device, the spring, or both, the retaining material comprising a material with a melting point that is at least substantially known, the retaining material configured to:
at least substantially prevent movement of the spring from the first spring position to the second spring position when a temperature of the brake device is below the melting point; and
allow movement of the spring from the first spring position to the second spring position when the temperature of the brake device is above the melting point.

16. The brake device of claim 15, wherein the retaining material comprises a eutectic alloy.

17. The brake device of claim 15, wherein the retaining material comprises a plastic.

18. The brake device of claim 15, wherein the retaining material is at least partially in a solid state around a coil of the spring when the temperature of the brake device is below the melting point.

19. The brake device of claim 15, wherein:
the rotor has a plurality of protruding edges; and
the emergency stop comprises one or more additional blocking devices, wherein the blocking device and the one or more additional blocking devices are aligned such that at least one of them contacts at least one of the plurality of protruding edges when the temperature of the brake device is above the melting point.

20. The brake device of claim 15, wherein the emergency stop is disposed proximate an end of the drive shaft.
